(19) United States
(12) Patent Application Publication
(10) Pub. No.: US 2004/0220922 A1
(43) Pub. Date: Nov. 4, 2004

(54) Systems and methods for meeting people via wireless communication among a plurality of wireless devices

(76) Inventors: Sean R. Lovison, Groton, CT (US); Joshua D. Lovison, San Diego, CA (US); David K. Lovison, Eugene, OR (US)

Correspondence Address: LUCE, FORWARD, HAMILTON & SCRIPPS LLP, 11988 EL CAMINO REAL, SUITE 200, SAN DIEGO, CA, 92130, US

(21) Appl. No.: 10/806,693

(22) Filed: Mar. 22, 2004

(30) Foreign Application Priority Data
Apr. 30, 2003 (JP) JP 2003-125600

(51) Int. Cl. G06F 7/00

(52) U.S. Cl. 707/3

(57) ABSTRACT

The present invention provides a system and method for identifying and retrieving information about individuals located within a geographic area, the system including a server having a database, a listening device associated with a requesting user and a plurality of broadcasting devices, wherein each broadcasting device is associated with a selected user. In operation, each broadcasting device emits a wireless data packet containing a UIE, wherein the listening device captures the wireless data packets, extracts the UIEs from the packets and sends the UIEs to the database. The database sends a profile of the selected users to the listening device in response to receiving the UIEs.

### FIELD OF THE INVENTION

This invention relates generally to systems and methods for wireless communication, and more particularly, to systems and methods for identifying and retrieving information about individuals located within a geographic area, using wireless communication.

### BACKGROUND OF THE INVENTION

The use of wireless signals is well known in the art of communication. For example, wireless signals are used for communication among cellular phones, laptop computers and many other wireless communication devices. Wireless signals are also utilized to establish wireless communication connections and identify the participating parties. A typical communication route between two parties will likely involve some level of integration of both analog and digital communication methodologies.

Wireless communication devices are affordable to an increasing number of users. Likewise, consumer demands for increased security and assuredness of wireless connections are also increasing. Consumers often have the hardware capabilities to establish such wireless connections. However, methods of utilizing existing and future wireless-based hardware and software to its full potential are not currently available.

There exist several implementations of network software operating in promiscuous mode, for example Intrusion Detection Systems such as Snort. In addition, there are several implementations of packets destined for a broadcast address, for example Address Resolution Protocol (ARP) requests in TCP/IP networking. Another growing technology is RFID, in which companies can tag their merchandise, products, materials, etc. with RFID tags for storing data about the item for later retrieval by scanning devices.

The use of online dating services has increased exponentially over the past few years. Many of these dating services allow users to search online for matches based on zip code or by country. Online dating services exist on the Internet using websites. The evolutionary next step would be to extend these services by making them available wirelessly. Some online dating services have begun to explore this possibility by partnering with wireless service providers to provide GPS localization using the GPS feature on a user's cell phone, and matching the online dating service's subscribers who are also customers of the wireless service provider. In addition, some online dating services have begun to provide their subscribers the ability to search their database using wireless Internet, however the user experience is very little different than if the user was home using their computer on the Internet. This invention provides users the ability to actively identify other subscribers who are in near proximity to their location, and can do so in real-time. This invention is not dependant on GPS or any other location finding method to accomplish this.

Considering the escalating demand for match-making services and the reality that such services depend largely on proximity between users, further localization of these services is the logical next step. Recent advances in wireless communication coupled with its growing popularity within consumer technologies make wireless communications a suitable medium for further localization of dating services as well as any need for proximity interaction and identification. Of course, the applications for the present invention are in no way limited to providing only dating services.

In view of the above, there exists a need for systems and methods for meeting people via wireless communication among a plurality of wireless devices.

### SUMMARY OF THE INVENTION

The present invention provides a system and method of using a wireless device as a tool to identify people within the same geographic area having similar interests. According to some embodiments, the wireless devices are cellular phones used to facilitate dating by people located within the same general region. Advantageously, the invention provides people with the opportunity to locate, learn about, and connect with other people living in their neighborhood. The systems and methods of the present invention preferably allow people to overcome the difficulties and awkwardness associated with meeting new acquaintances for example when moving to a new city or when looking for a significant other. The systems and methods of the present invention can also be extended to interact with people in various other scenarios.

According to a preferred embodiment of the present invention, a Mobile Connecting Service (MCS) provides its users with software for their wireless devices that are employed to automatically filter other users in the same geographic area to identify those who have similar interests. The wireless devices are used to detect and identify wireless signals to establish common relationships and various levels of communication. A filter is provided on each wireless device to facilitate meeting people having similar interests and hobbies. For example, a woman who enjoys sewing may set her filter to identify other women who list sewing as a hobby. Likewise, a person may set their filter to identify others who are interested in mountain biking, kayaking, Star Trek and just about any other activity. As a further example, a business person may wish to be identified with special interests at a trade show.

According to one aspect of the present invention, a system for identifying and retrieving information about individuals located within a geographic area comprises a server having a database, a listening device associated with a requesting user and a plurality of broadcasting devices, wherein each broadcasting device is associated with a selected user. In operation, each broadcasting device emits a wireless data packet containing a unique identification entity (UE), wherein the listening device captures the wireless data packets, extracts the UIEs from the packets and sends the UIEs to the database. The database sends a profile of the selected users to the listening device in response to receiving the UIEs.

According to another aspect of the present invention, a method of identifying and retrieving information about individuals located within a geographic area, comprises the step of providing a listening device associated with a requesting user and a plurality of broadcasting devices, wherein each broadcasting device is associated with a selected user, wherein each broadcasting device emits a wireless data packet containing a UIE. The method further includes the steps of providing a server for the network of devices, the server including a database, capturing the wireless data packets using the listening device, extracting the UIEs from the data packets using the listening device and sending the UIEs to the database using the listening device. According to some embodiments, each device is both a broadcasting device and a listening device. In other words, a device is a broadcasting device while it is broadcasting and a listening device when it is not broadcasting.

### BRIEF DESCRIPTION OF THE DRAWINGS

These and other features and advantages of the invention will become more apparent upon reading the following detailed description and upon reference to the accompanying drawings.

FIG. 1 is a block diagram of a system for identifying and retrieving information about individuals located within a geographic area, using wireless communication, according to the principles of the present invention;

FIG. 2 is a block diagram of an alternative system for identifying and retrieving information about individuals located within a geographic area, using wireless communication, according to the principles of the present invention;

FIG. 3 is a block diagram of a further alternative system for identifying and retrieving information about individuals located within a geographic area, using wireless communication, according to the principles of the present invention;

FIG. 4 is a block diagram of an additional alternative system for identifying and retrieving information about individuals located within a geographic area, using wireless communication, according to the principles of the present invention;

FIG. 5 is a flowchart of a method of identifying and retrieving information about individuals located within a geographic, using wireless communication, according to the principles of the present invention;

FIG. 6 is a block diagram of a system for identifying and retrieving information about individuals located within a geographic area, using wireless communication, wherein the wireless devices adapted to retransmit received wireless signals; and

FIG. 7 is a block diagram of a system for identifying and retrieving information about individuals located within a geographic area, using wireless communication, wherein the software program is capable of more than one wireless protocol.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

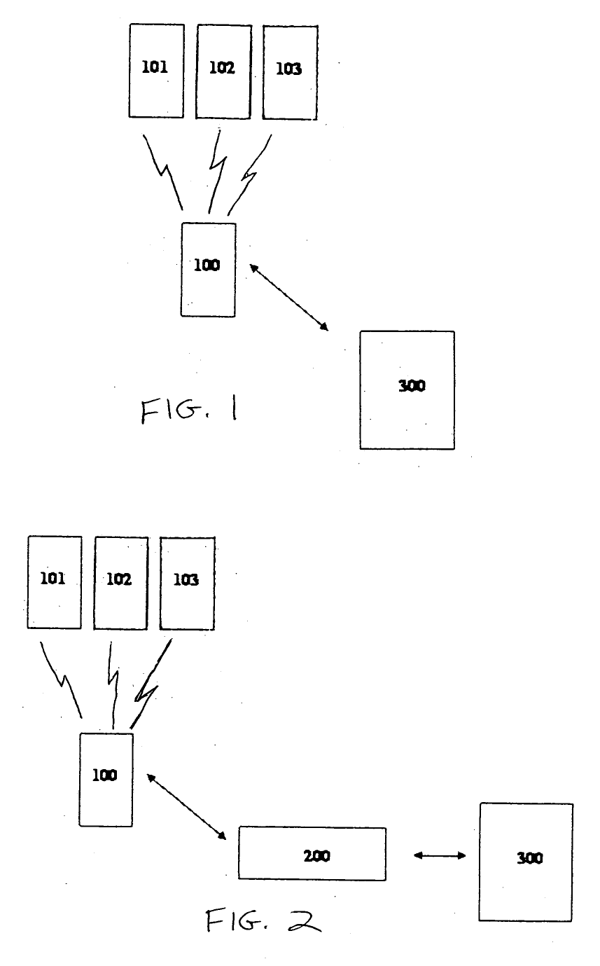

Referring to FIG. 1, a system 10 for people interaction via wireless communication comprises wireless device 100 provided in communication with server 300. In addition wireless devices 101, 102, 103 are provided in wireless communication with wireless device 100. Wireless devices 101, 102, 103 may also been in communication with server 300 depending on whether they are within a predetermined reception range. As would be appreciated by one of skill in the communications art, any number of wireless devices and servers may be provided without departing from the scope of the present invention.

The system preferably is provided by a Mobile Connecting Service (MCS), which provides wireless connectivity via a software program that resides on server 300 as well as each wireless device. The software program comprises machine readable or interpretable instructions enabling communication between server 300 and wireless devices 100, 101, 102, 103 as well as among wireless devices 100, 101, 102, 103. Network service users utilize wireless devices 100, 101, 102, 103 to transmit signals containing digital data. The digital data identifies the signals with the transmitting device and may also contain digital data corresponding to the user of the transmitting device. In operation, a plurality of servers 300 may be located in different geographic regions, wherein each server 300 is designated to cover a particular region. In a preferred embodiment, all such servers and their corresponding wireless devices share the common software disclosed above with respect to FIG. 1.

Wireless devices comprise any devices capable of bidirectional communication between each other and the server without the use of physical connection, and with utilizing one or more digital processors, and some form of data storage. The field of digital wireless devices is constantly evolving, and future wireless devices developed in this field are intended to be covered by the scope the present invention. Currently known wireless devices that are suitable for use include, but are in no way limited to, cellular phones, wireless phones, mobile phones, smart phones, WAP phones, tablet computers, PDAs and handheld gaming devices.

In a preferred embodiment, system 10 comprises a Wireless Personal Area Network (WPAN), which is a wireless network for interconnecting devices centered around an individual or around multiple individuals, at the same time or at different times. An individual, as used in this patent, is defined by a single wireless device rather than a single user. A wireless device can be installed on a wall or on a sign such that a user is not present during operation of the wireless device. Further, a user may possess more than one wireless device, and any of the user's wireless devices may be the center of the WPAN, at the same time or at different times. As used in this patent, the term WPAN does not include any distance limitation, nor does it include any current or future limitation of range proposed by any individual or organization or group as part of any definition of the term WPAN.

Examples of packet based wireless networks suitable for use with the present invention include, but are not limited to, WiFi-802.11 networks, 802.11a, 802.11b, 802.11g, homeRF2, HiperLAN2, 5-UP, Bluetooth wireless scattemets and piconets, Wireless Local Area Networks (WLAN) and Wireless Metropolitan Area Networks (WMAN). As would be appreciated by those of ordinary skill in the art, the network may comprise any number of wireless devices and servers without departing from the scope of the present invention.

A wireless device 100 may receive signals from other wireless devices 101, 102, 103 when the signals are within reception range. Advantageously, signaling among users using wireless devices 100, 101, 102, 103 may occur simultaneously. In accordance with an aspect of the present invention, the software program within wireless devices 100, 101, 102, 103 enables automatic and manual filtering of incoming signals. By way of example, the software may be programmed to filter out signals from particular wireless devices if the corresponding signals fail to meet the filter criteria. After signals from another wireless device (e.g., device 102) have passed the filter, wireless device 100 can automatically or manually query server 300 for additional information about the user of wireless device 102.

Upon receiving the query, server 300 can perform further filtering of incoming signals based upon additional information residing on the server as part of a database. Signals that survive filtering are matched to the database information concerning the corresponding users. The database information is sent back to wireless device 100 for viewing by the user. At this point, the user can review the database information and automatically or manually contact users of their choice. According to a preferred embodiment, users may change their server data through a secured network connection from a computer, cell phone, or any other mobile device having the ability to make the secured connection.

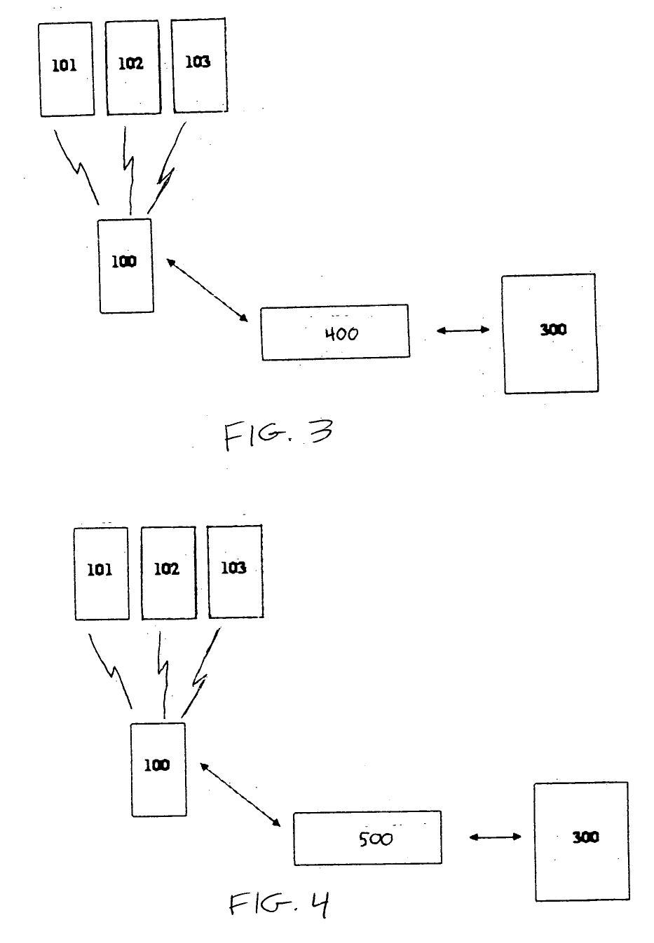

Referring to FIG. 2, according to some embodiments, system 10 further comprises communication equipment 200 used to link wireless devices 100, 101, 102, 103 and server 300. Communication equipment 200 represents any conventional communications hardware and supporting software that provides links between wireless devices 100, 101, 102, 103 and server 300. Depending on the local and remote system topology, communication equipment 200 may include various types and numbers of auxiliary networks, phone lines, high speed fiber optic backbones, routers, gateways and other conventional communication equipment that handles network traffic.

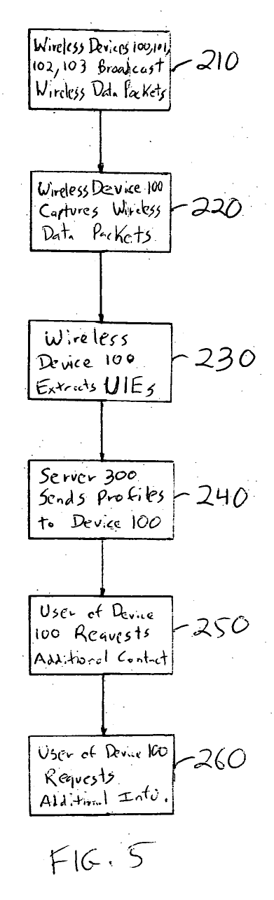

Referring to FIG. 3, system 10 optionally includes a range extender 400 for extending the range to access server 300. Range extender 400 comprises one or more routers that can route signal digital data to other locations that extends the effective access range to server 300. Referring to FIG. 4, system 10 optionally includes one or more additional servers 500. Any additional servers 500 preferably contain the software program and a subset of the user database information for the purpose of non-carrier lookup for events where connections to server 300 are limited.

As discussed above, the present invention provides an MCS utilizing wireless devices to connect people located within the same general geographic area. In a preferred embodiment, the wireless device comprises a cellular phone. According to some embodiments, an online service is provided at a secure web page for user registration. A user's profile is then associated with the wireless device.

Each cellular phone preferably includes a broadcast mode through a network device such as, for example, a Bluetooth interface, wherein the wireless data packet is broadcast to the other cellular phones at predetermined intervals. By way of example a phone may be programmed to broadcast its wireless data packet once every five seconds when in the broadcast mode.

A user preferably is able to detect other users by automatically or manually setting, using the software program, the network device on their phone into a “listening mode.” In the listening mode, all broadcasted wireless data packets within the transmittable radius are captured and recorded as a “hit”. From the captured wireless data packets, the UIEs are then transmitted to the information database residing on the server. The server pairs the UIEs with corresponding user profile data, and returns the user profile data to the requesting user's cellular phone. According to some embodiments, the UIEs are paired with corresponding photos corresponding to each of the recorded hits. After viewing the photos, the user can selectively retrieve additional user profile data of particular users. Upon finding an individual user of interest, the requesting user may utilize the acquired user profile data as an “ice breaker” with the selected user.

After reviewing the user profile data, the requesting user can reinitiate contact with the server database and request additional profile data concerning one or more users. In addition, the requesting user may attempt to initiate contact with a selected user by transmitting a request to the database to send the requesting user's photo to the selected user. The request may also ask for direct contact with the selected user. If the selected user grants consent, direct contact may be arranged in a number of alternative ways. According to some embodiments, a telephonic conversation may be arranged featuring the use of a middle man device to mask the user's phone numbers. For example, the database may serve as the middle man device. According to other embodiments, contact between consenting users may be provided by way of text messaging.

Referring to FIG. 5, a method of identifying and retrieving information about individuals located within a geographic area will now be described. Initially, each of a plurality of wireless devices 100, 101, 102, 103 located within a particular region periodically broadcast a wireless data packet containing a UIE (step 210). At step 220, wireless device 100 is operating in listening mode, wherein wireless device 100 captures the wireless data packet of those devices 101, 102, 103 that are within transmission range. At step 230, wireless device 100 extracts the UIEs from the data packets and sends the UIEs to server 300.

Upon receiving the UIEs, the server database sends user profiles corresponding to the UIEs to wireless device 100 (step 240). This step may involve the step of sending a photograph of the selected users to wireless device 100. After reviewing the user profiles, the user of wireless device 100 may send a request for an additional form of contact to the server database (step 250). As disclosed above, the additional form of contact may comprise a telephone call, wherein the telephone phone numbers are masked for privacy purposes. Alternatively, the additional form of contact may be a text message. The user of wireless device 100 may also request additional information from the server database pertaining to one or more of the selected users (step 260).

According to additional embodiments, a requesting user may also send a “Go/No Go” signal to a selected user, whereby the selected user is prompted to indicate whether they have an interest in meeting the requesting user. In response, the selected user can view the photo and other user profile data of the requesting user, and then reply with a “Go” or “No Go”. Alternatively, the selected user may reply with a text message containing their response. As a further alternative, the selected user may reply with a “call me” signal, wherein the requesting user is prompted to allow an automatic connection with the selected user.

As a real life example, assume that a user is located in a crowded venue such as a night club or sports arena, and the user desires to know how many other users are present at the same venue. By activating the listening mode, the user's cellular phone detects all other members located within transmission range and the cellular phone automatically displays the number of hits and can automatically or manually retrieve the corresponding user photos. The requesting user may proceed to selectively retrieve additional user profile data of particular users and/or contact selected users as described above.

According to some embodiments of the present invention, users may elect to receive targeted advertisements on their wireless device. Conversely, vendors may become authorized advertisers that send out signals to selected wireless devices. By way of example, assume that one or more users are shopping at a mall having a plurality of stores therein. One of these stores is a clothing store that is an authorized advertiser using the software of the present invention. During mall hours, the store broadcasts signals to users shopping at the mall. Advantageously, the signals may be targeted to specific groups (e.g., men only, women only, persons over 25 years old, and other groups). For example, female users at the mall are sent a targeted advertisement indicating that the clothing store will provide them with an additional twenty percent off all women's clothing for the duration of the day. On the other hand, male users at the mall are sent a targeted advertisement indicating that the clothing store will provide them with an additional fifteen percent off all men's clothing for the duration of the day. The targeted advertisements may be readily changed or supplemented in real-time throughout the day.

Referring to FIG. 6, a system 20 for wireless communication comprises an MCS including a wireless device 320, which emits wireless packets of data to wireless devices 104, 105, 106. The software program of the present invention resides on wireless device 320 as well as the other wireless devices 104, 105, 106. As would be understood to those of skill in the art, system 20 may feature any number of additional wireless devices without departing from the scope of the present invention. Wireless device 320 has a limited transmission range such that wireless signals directly reach wireless device 104, but cannot directly reach wireless devices 105, 106. According to an aspect of the present invention, upon receiving packets of data from wireless device 320, wireless device 104 retransmit the packets of data to wireless device 105, which is located within its transmission range. Wireless device 105 receives the transmission from wireless device 104, and then retransmits the packets of data to wireless device 106, which is located within its transmission range. In this manner, the effective transmission range of wireless device 320, as well as the effective transmission range of each wireless device 104, 105, 106 is significantly extended.

Preferably, the system 20 is designed such that each successive retransmission of wireless data decrements a time-to-live (TTL) value. In other words, the TTL value is decremented prior to each re-transmission of a packet of data, thereby providing a controlled range of dissemination. According to some embodiments, an original TTL value is duplicated yet not decremented when received by a wireless device. According to other embodiments, the software can recognize and therefore ignore packets originating from its own wireless device.

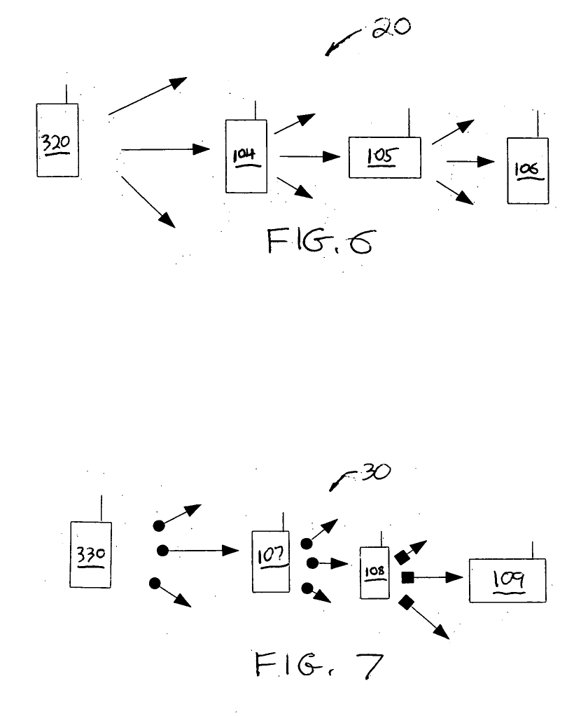

The software program of the present invention preferably is capable of more than one wireless protocol such that a wireless device may receive a data packet under a first protocol and send it out under a second protocol. By providing wireless devices with more than one wireless protocol, the universality of the data packet is extended. By way of example, referring to FIG. 7, a system 30 for wireless communication comprises an MCS including a wireless device 330 and wireless devices 107, 108, 109, all of which run the software program of the present invention.

In the illustrated embodiment, wireless device 330 is a device that emits wireless data packets according to a first protocol. Wireless device 107 is a device of the first protocol which receives the wireless data packets from server 330 and retransmits them according to the first protocol. Wireless device 108 is a device of the first protocol and a second protocol. After wireless device 108 receives the data packets from server 330 according to the first protocol, it retransmits them according to the first protocol as well as the second protocol. Wireless device 109 is a device of the second protocol, which receives the wireless data packets from wireless device 108 according to the second protocol. As would be understood to those of skill in the art, additional servers, wireless devices, and protocols may be employed without departing from the scope of the present invention.

The wireless devices of the present invention preferably are registered to the information database for the purpose of establishing a unique identification entity (UIE) for each wireless device. These UIEs are based in part on the unique identification information of the wireless device. This device-to-database registration process includes registration of the software program residing on the device to the database. In addition, the registration process preferably involves linking each wireless device to a primary user by assigning the UIE to the primary user. The primary user may be a person, a business entity, a group of persons, or any identity capable of registration.

According to some embodiments, more than one user may be registered to a single UIE. Optionally, UIEs may also be linked with location-specific information such as GPS and cell location information. Further, personal and/or private information stored remotely from the user's wireless device may be linked with the UIEs. Optionally, a primary user may disavow their UIE from their personal ownership, thereby permitting the primary user to un-register a previously registered wireless device from their profile. According to some embodiments, a primary user may desire more than one wireless device registered to them as the primary user. Accordingly, the primary user is provided with multiple UIEs that are unified to a single user profile.

Thus, it is seen that systems and methods for wireless communication for identifying and retrieving information about individuals located within a geographic area are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A system for identifying and retrieving information about-individuals located within a geographic area, the system comprising:
a plurality of broadcasting devices, each broadcasting device being associated with a selected user;
a listening device associated with a requesting user; and
a server including a database;
wherein each broadcasting device emits a wireless data packet containing a unique identification entity (UIE);
wherein the listening device captures the wireless data packets, extracts the UIEs from the packets and sends the UIEs to the database.

2. The system of claim 1, wherein the database sends a profile of the selected users to the listening device in response to receiving the UIEs.

3. The system of claim 1, wherein the database sends a photograph of the selected users to the listening device in response to receiving the UIEs.

4. The system of claim 2, wherein the requesting user sends a request for an additional form of contact with one or more of the selected users to the database after reviewing the user profiles.

5. The system according to claim 4, wherein the additional form of contact is a phone call, wherein the phone numbers can be masked for privacy.

6. The system of claim 4, wherein the additional form of contact is a text message.

7. The system of claim 1, wherein:
the requesting user sends a request to contact one or more of the selected users to the database; and
the database acts as a middle man to transmit information between the listening device and the broadcasting device.

8. The system of claim 1, wherein the listening device and the broadcasting device are wireless devices capable of bi-directional communication with each other and with the database.

9. The system of claim 1, wherein the listening device and the broadcasting device are cellular phones capable of bi-directional communication with each other and with the database.

10. The system of claim 1, wherein the listening device and the broadcasting device are computers capable of bi-directional communication with each other and with the database.

11. The system of claim 1, wherein the listening device and the broadcasting device are PDAs capable of bidirectional communication with each other and with the database.

12. The system of claim 1, wherein the wireless data packets have a predefined number of bits reserved for filtering purposes.

13. The system of claim 1, further comprising a software program residing on the database and on each wireless device, the software program enabling communication among the database and the wireless devices.

14. The system of claim 13, wherein the software program is adapted to filter incoming wireless transmissions.

15. The system of claim 13, wherein the software program is capable of more than one wireless protocol.

16. The system of claim 1, wherein each wireless device is adapted to transmit and receive signals wirelessly.

17. The system of claim 1, further comprising a range extender for extending the effective transmission range of the wireless device.

18. The system of claim 17, wherein the range extender comprises one or more routers and hubs.

19. The system of claim 1, wherein the users may elect to receive targeted advertising on their respective devices.

20. The system of claim 1, wherein the wireless devices are adapted to retransmit wireless data packets once they are received, thereby extending the effective range of the devices.

21. The system of claim 20, wherein each retransmission decrements a time-to-live value, thereby providing a controlled range of transmission.

22. The system of claim 20, wherein the devices are capable of more than one wireless protocol such that a device may receive a wireless data packet under a first protocol and retransmit the wireless data packet under a second protocol.

23. A method of identifying and retrieving information about individuals located within a geographic area, comprising the steps of:
providing a listening device associated with a requesting user and a plurality of broadcasting devices, wherein each broadcasting device is associated with a selected user, wherein each broadcasting device emits a wireless data packet containing a UIE;
providing a server for the network of devices, the server including a database;
capturing the wireless data packets using the listening device;
extracting the UIEs from the data packets using the listening device; and
sending the UIEs to the database using the listening device.

24. The method of claim 23, further comprising the step of sending a profile of each selected user to the listening device using the server.

25. The method of claim 23, further comprising the step of sending a photograph of each selected user to the listening device using the server.

26. The method of claim 24, further comprising the step sending a request for an additional form of contact with one or more of the selected users to the database using the listening device.

27. The method according to, claim 26, wherein the additional form of contact is a phone call, wherein the phone numbers can be masked for privacy.

28. The method of claim 26, wherein the additional form of contact is a text message.

29. The method of claim 23, wherein the listening device and the broadcasting device are wireless devices capable of bidirectional communication with each other and with the database.

30. The method of claim 23, wherein the listening device and the broadcasting device are cellular phones capable of bi-directional communication with each other and with the database.

31. The method of claim 23, wherein the listening device and the broadcasting device are computers capable of bi-directional communication with each other and with the database.

32. The method of claim 23, wherein the listening device and the broadcasting device are PDAs capable of bi-directional communication with each other and with the database.

33. The method of claim 23, wherein the wireless data packets have a predefined number of bits reserved for filtering purposes.

34. The method of claim 23, wherein a software program resides on the server and on each wireless device, the software program enabling communication among the database and the wireless devices.

35. The method of claim 34, wherein the software program is adapted to filter incoming wireless transmissions.

36. The method of claim 34, wherein the software program is capable of more than one wireless protocol.

37. The method of claim 23, further comprising the step of providing a range extender for extending the effective transmission range of the wireless device.

38. The method of claim 37, wherein the range extender comprises one or more routers and hubs.

39. The method of claim 23, further comprising the step of retransmitting wireless data packets once they are received using the broadcasting devices, thereby extending the effective range of the devices.

40. The method of claim 39, wherein each retransmission decrements a time-to-live value, thereby providing a controlled range of transmission.

41. The method of claim 39, wherein the broadcasting devices are capable of more than one wireless protocol such that a device may receive a wireless data packet under a first protocol and retransmit the wireless data packet under a second protocol.

42. The method of claim 23, wherein users may elect to receive targeted advertising on their respective devices.
